(19) United States
(12) Patent Application Publication
(10) Pub. No.: US 2018/0246597 A1
(43) Pub. Date: Aug. 30, 2018

(54) WRITEABLE ELECTROPHORETIC DISPLAY AND PEN CONFIGURED TO WRITE ON ELECTROPHORETIC DISPLAY WITH DISAPPEARING INK AND ELECTROMAGNETIC SENSING

(71) Applicant: E INK CALIFORNIA, LLC, Fremont, CA (US)

(72) Inventors: Ming WANG, Fremont, CA (US); Vladimir SOFIYEV, Oakland, CA (US); Lin SHAO, Fremont, CA (US); HongMei ZANG, Fremont, CA (US)

(21) Appl. No.: 15/906,034

(22) Filed: Feb. 27, 2018

Related U.S. Application Data
(60) Provisional application No. 62/464,494, filed on Feb. 28, 2017.

(51) Int. Cl. G06F 3/044; G06F 3/046; G06F 3/0354; G09G 3/34; G06F 3/041; G02F 1/167

(52) U.S. Cl. CPC G06F 3/044; G06F 3/046; G06F 3/03545; G02F 2201/123; G06F 3/0416; G02F 1/167; G02F 2001/1676; G09G 3/344

(57) ABSTRACT

A writeable system that includes pen-like visual feedback and digitization of the stylus strokes. The system incorporates disappearing ink into a stylus (i.e., pen) that is configured to interact with a digitizing layer of an electrophoretic display. The electrophoretic display includes a clear protective sheet that can be written on with the disappearing ink. As the stylus is moved over the display, an ink trail is left on the display, however, after a short amount of time, the ink fades as the writing in replaced with an updated image corresponding to the stylus motion.

### RELATED APPLICATIONS

This application claims priority to U.S. Provisional Application No. 62/464,494, filed Feb. 28, 2017, the contents of which is incorporated herein by reference in its entirety.

### BACKGROUND OF INVENTION

This invention relates to writable electronic tablets, which allow users to take notes, draw figures, and edit documents electronically. In some embodiments, the writable electronic tablets record the writings/drawings and convert them into a digital format that is easily saved, recalled, and shared.

A number of LCD-based tablets are commercially-available that have the ability to record a user's writing, drawing, or mark-up of documents. For example, the Microsoft SURFACE® Pro 4 (Microsoft Corporation, Redmond, Wash.) comes with a stylus (SURFACE PEN®) that allows a user to take notes, draw, and mark-up documents that are viewed on the LCD touch screen. The position of the stylus is tracked by broadcasting a signal from the stylus tip to the capacitive touch screen of the tablet, whereby a proximity-sensing algorithm is used to determine the location of the stylus. Other LCD-based tablets, such as the Sony VAIO LX900 (Sony Corporation, Tokyo, Japan) use the digitizing technology of Wacom (Wacom Co. Ltd., Kazo, Japan) whereby the stylus tip (including an inductive loop) is located by an energized digitizing layer located behind the LCD display. The digitizing layer typically comprises a grid of overlapping electrodes adjacent a magnetic film. The stylus head in the Wacom system includes an inductive coil, and the motion of the coil during writing can be translated into a position with respect to the grid defined by the electrodes in the digitizing layer.

A common complaint from users is that these LCD-based tablets do not provide a “paper-like” experience. First, because the LCD is power-hungry, the screen will typically go dark when the tablet is not in active use. This means that a user has to “wake up” the device to start writing, and often has to reawaken the device during a writing session because the device went “to sleep” while the user was listening to a speaker, or otherwise engaged in a different task. Secondly, the stylus strokes do not feel or look like writing on paper because the texture, depth, and latency of the writing device is perceptible different that using a pen on real paper. Often when writing on an LCD display with a pen, a user has the sense that he/she is dragging a plastic stick across a plate of glass. Furthermore, when using these types of electronic tablets, the writing has a “depth” into the viewing surface that is disorienting. The written words are not at the top surface interacting with the stylus, but rather disconnected from the stylus tip.

Alternate electronic writing devices have been constructed using light-reflective media, such as electrophoretic ink (E Ink Corporation, Billerica, Mass.). See, for example, the DPTS1™ from Sony (Sony Corporation, Tokyo, Japan). Electrophoretic ink solves many of the “sleeping” problem of LCD-based writing systems because the devices are always “on”, They consume far less power during the writing process so they don't need to go to sleep except when prompted by the user, and even after they are asleep they continue to display the writing. Additionally, because the electrophoretic ink is very close to the surface of the device, the stylus response looks more like writing. The devices are also sunlight-readable, which makes it possible to use the device outdoors or in other bright-light environments. Some commercially-available electrophoretic ink devices, such as the ReMARKABLE™ tablet (REMARKABLE A.S., Oslo, Norway), also include high-friction surface materials that create a “feel” that is far more paper-like. While such friction materials can be included on LCD displays, the materials can interfere with the image quality of the LCD because the friction materials scatter the light emitted from the display.

Regardless of the format (LCD or electrophoretic ink), users of electronic (tablet) display writing systems typically experience distracting latency between stylus movement and image updates when writing. This latency is caused by the time that is required to sense the position of the stylus and update the image driver so that the movement of the stylus is accurately portrayed as writing/drawing on the screen. The latency is the additive delay of a series of steps such as sensing the position of the stylus, sending the position information to the display driver, processing the display change, and refreshing the display. In many cases, the position information is additionally saved to memory to allow the user to later recall the notes, and this saving step may add an additional small delay. In LCD-based systems, the latency is typically on the order of 60 ms. Many users find the latency to be distracting, and in some cases, the latency limits the speed that a user can take notes, draw, etc.

In addition to the sensing and saving the position information, there may be additional lag time associated with refreshing the image to show the writing. For example, electrophoretic ink systems often have latencies of at least 100 ms because of the additional time (20-40 ms) that it takes to drive the electrophoretic particles between image states after the update is sent to the pixels. In addition, the latency may vary depending upon what portion of the display is being updated. That is, the latency is different across the display surface because the display driver updates the scan lines in an orderly fashion. For example, the latency may be more noticeable when writing in the lower right-hand corner of a tablet versus the upper left-hand corner.

To counter the latency, many manufacturers use predictive algorithms to reduce the number of updates needed to capture the writing. These predictive algorithms may, for example, process the previous letters that were written and predict the next letters. The algorithms may also employ a rolling average to anticipate straight lines or use smoothing to account for fluctuations in pen sensing. Nonetheless, such algorithms can result in unintended strokes being generated which can be just as distracting to a user as waiting for updates.

### SUMMARY OF INVENTION

The invention addresses several shortcomings of the prior art by providing a writeable display medium that is paper-like and allows instantaneous text updates as a pen is moved across the surface of the display. The writeable system includes an electrophoretic display and a disappearing-ink pen. The electrophoretic display includes a light-transmissive front electrode, a protective sheet covering the light-transmissive front electrode, an array of pixel electrodes, an electrophoretic medium sandwiched between the light-transmissive front electrode and the array of pixel electrodes, and a digitizing layer configured to locate a touch on the electrophoretic display. The disappearing-ink pen includes a source of disappearing ink and, in addition, the pen is configured to write on the protective sheet with the disappearing ink while interacting with the digitizing layer. The protective sheet will typically be made from high density polyethylene (HDPE), polyvinylchloride (PVC) or another clear chemical resistant material. The protective sheet may also be glass, glass with a specialty coating, or micro-etched glass. Micro-etched glass can be produced using, e.g., hydrofluoric spray nozzles from Sonaer (West Babylon, N.Y.). The invention allows a user to have a paper-like writing experience because the pen is actually laying down temporary ink. Nonetheless, a user also gets the benefit of digitization in that the text, design, drawings, etc. are converted into an electronic file that can be saved and shared.

Often the electrophoretic display will be operatively coupled to a power source and a display driver. The electrophoretic display may also be coupled to memory that can be used to receive position information from the digitizing layer and to send the position information to the display driver. The digitizing layer may use either electromagnetic or capacitive sensing.

The pen of the writeable system includes A) a source of disappearing ink, and B) an electromagnetic or capacitive coupling element that allows the pen to interact with the digitizing layer of the electrophoretic display. The ink typically comprises thymolphthalein or phenolphthalein in a mildly basic solution. As a user writes on the display, the disappearing ink provides instantaneous feedback in the form of inked characters. The ink is gradually neutralized by the carbon dioxide in the air, thereby causing the ink to disappear. As the ink disappears, the display is rewritten using the digitizing information that has been simultaneously recorded and processed into a digital image. In some embodiments, it may be helpful to remove residue from the disappearing ink on the protective sheet with a mildly acid cleaning solution, such as a dilute vinegar.

### BRIEF DESCRIPTION OF DRAWINGS

FIG. 1 is a general depiction of an electrophoretic medium, suitable for use in the invention;

FIG. 2 illustrates writing to a writeable display of the invention with a pen;

FIG. 3 depicts a writeable display system of the invention;

FIG. 4 illustrates the temporary appearance of lines written with a pen of the invention and those lines being updated with images corresponding to the motion of the pen;

FIG. 5 illustrates an embodiment of a pen suitable for use with an electrophoretic display of the invention;

### DETAILED DESCRIPTION

As indicated above, the present invention provides a writeable system that includes pen-like writing updates as well as digitization of the pen strokes. The invention is made possible by incorporating disappearing ink into a pen that is configured to interact with a digitizing layer of an electrophoretic display. The electrophoretic display includes a clear protective sheet that can be written on with the disappearing ink. As the pen is moved over the display, an ink trail is left on the display, very similar to writing on paper with a pen. After a short amount of time; the ink fades as the writing in replaced with an updated image corresponding to the pen strokes. Thus, the writeable system overcomes much of the disorienting feedback that users experience with other electronic writeable tablet systems. Additionally, because the digitizing system is recording the position of the pen, the writing can be recorded electronically and transformed into an electronic image file, e.g., for electronic transfer and saving.

The invention is intended to be used with electrophoretic media of the type developed by E Ink Corporation (Billerica; MA) and described in the patents and patent publications listed below. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include: (a) Electrophoretic particles, fluids and fluid additives; see for example U.S. Pat. Nos. 7,002,728 and 7,679,814; (b) Capsules, binders and encapsulation processes; see for example U.S. Pat. Nos. 6,922,276 and 7,411,719; (c) Microcell structures, wall materials, and methods of forming microcells; see for example U.S. Pat. Nos. 7,072,095 and 9,279,906; (d) Methods for filling and sealing microcells; see for example U.S. Pat. Nos. 7,144,942 and 7,715,088; (e) Films and sub-assemblies containing electro-optic materials; see for example U.S. Pat. Nos. 6,982,178 and 7,839,564; (f) Backplanes, adhesive layers and other auxiliary layers and methods used in displays; see for example U.S. Pat. Nos. 7,116,318 and 7,535,624; (g) Color formation and color adjustment; see for example U.S. Pat. Nos. 7,075,502 and 7,839,564; and (h) Methods for driving displays; see for example U.S. Pat. Nos. 7,012,600 and 7,453,445. All of the patents and patent applications listed herein are incorporated by reference in their entirety.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

While the invention is primarily directed to electrophoretic media of the type described above and in the listed patents and patent applications, other types of electro-optic materials may also be used in the present invention. The alternative electro-optic media are typically reflective in nature, that is, they rely on ambient lighting for illumination instead of a backlight source, as found in an emissive LCD display. Alternative electro-optic media include rotating bichromal member type media as described, for example, in U.S. Pat. Nos. 5,808,783; 5,777,782; 5,760,761; 6,054,071 6,055,091; 6,097,531; 6,128,124; 6,137,467; and 6,147,791. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another alternative electro-optic display medium is electrochromic, for example an electrochromic medium in the form of a nanochrornic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

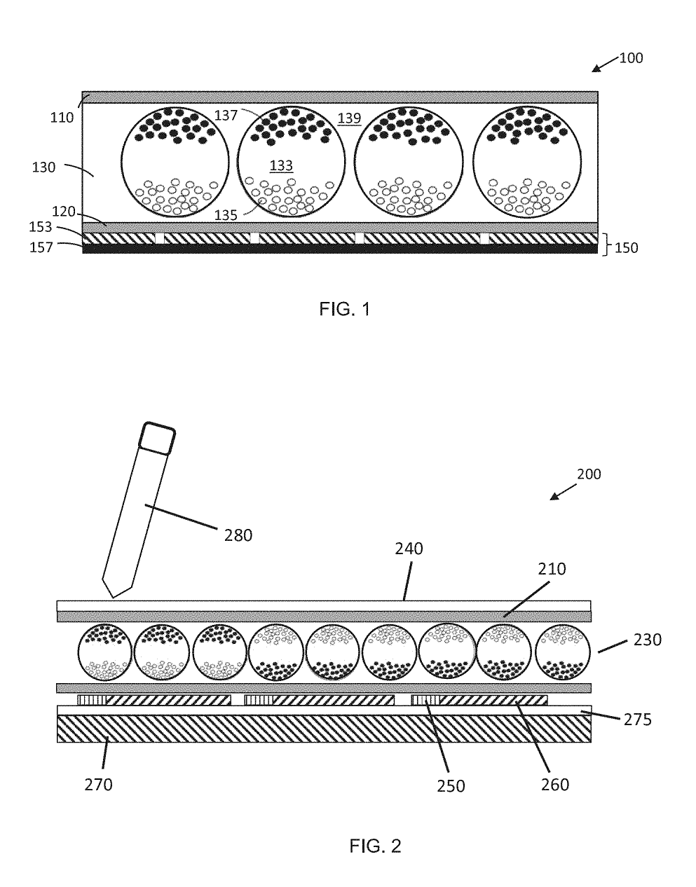

An exemplary electrophoretic display (EPID) is show in FIG. 1. Display 100 normally comprises a layer of electrophoretic material 130 and at least two other layers 110 and 120 disposed on opposed sides of the electrophoretic material 130, at least one of these two layers being an electrode layer, e.g., as depicted by layer 110 in FIG. 1. The front electrode 110 may represent the viewing side of the display 100, in which case the front electrode 110 may be a transparent conductor, such as Indium Tin Oxide (ITO) (which in some cases may be deposited onto a transparent substrate, such as polyethylene terephthalate (PET)). Such EPIDs also include, as illustrated in FIG. 1, a backplane 150, comprising a plurality of driving electrodes 153 and a substrate layer 157. The layer of electrophoretic material 130 may include microcapsules 133, holding electrophoretic pigment particles 135 and 137 and a solvent, with the microcapsules 133 dispersed in a polymeric binder 139. Nonetheless, it is understood that the electrophoretic medium (particles 135 and 137 and solvent) may be enclosed in microcells (microcups) or distributed in a polymer without a surrounding microcapsule (e.g., PDEPID design described above). Typically, the pigment particles 137 and 135 are controlled (displaced) with an electric field produced between the front electrode 110 and the pixel electrodes 153. In many conventional EPIDs the electrical driving waveforms are transmitted to the pixel electrodes 153 via conductive traces (not shown) that are coupled to thin-film transistors (TFTs) that allow the pixel electrodes to be addressed in a row-column addressing scheme. In some embodiments, the front electrode 110 is merely grounded and the image driven by providing positive and negative potentials to the pixel electrodes 153, which are individually addressable. In other embodiments, a potential may also be applied to the front electrode 110 to provide a greater variation in the fields that can be provided between the front electrode and the pixel electrodes 153.

While END media are described as “black/white,” they are typically driven to a plurality of different states between black and white to achieve various tones or “grayscale.” Additionally, a given pixel may be driven between first and second grayscale states (which include the endpoints of white and black) by driving the pixel through a transition from an initial gray level to a final gray level (which may or may not be different from the initial gray level). The term “waveform” will be used to denote the entire voltage against time curve used to effect the transition from one specific initial gray level to a specific final gray level. Typically, such a waveform will comprise a plurality of waveform elements; where these elements are essentially rectangular (i.e., where a given element comprises application of a constant voltage for a period of time); the elements may be called “pulses” or “drive pulses.” The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible to use more than one drive scheme simultaneously in different areas of the same display, and a set of drive schemes used in this manner may be referred to as “a set of simultaneous drive schemes.”

The manufacture of a three-layer electrophoretic display normally involves at least one lamination operation. For example, in several of the aforementioned patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane (see FIG. 1), containing an array of pixel electrodes and an appropriate arrangement of conductors to connect the pixel electrodes to drive circuitry is prepared. To form the final display, the substrate having the capsule/binder layer thereon is laminated to the backplane using a lamination adhesive. In embodiments where it is desired to have additional layers, such as a digitizing sensor layer (Wacom Technologies, Portland, Oreg.), those layers may be inserted between the electrode layer and the substrate, or an additional substrate may be added between the electrode layer and the additional layer. In one preferred embodiment, the backplane is itself flexible and is prepared by printing the pixel electrodes and conductors on a plastic film or other flexible substrate. The lamination technique for mass production of displays by this process is roll lamination using a lamination adhesive.

During the lamination process, one or more lamination adhesives are used to provide mechanical continuity to the stack of components and also to assure that the layers are relatively planar with respect to each other. In some instances commercial lamination adhesives (lamad) can be used, however, manufacturers of lamination adhesives (naturally) devote considerable effort to ensuring that properties, such as strength of adhesion and lamination temperatures, while ignoring the electrical properties of the lamination adhesive. Accordingly, manufactures of electrophoretic displays typically modify commercial adhesives to achieve the needed volume resistivity. Methods for modifying the electrical properties of commercial adhesives are described in several of the before mentioned patents. The methods typically involve adding charged copolymers, charged moieties, or conductive particles.

An embodiment of a writeable system of the invention is shown in FIG. 2. It is similar to the generalized electrophoretic display of FIG. 1, however it additionally includes a digitizing layer 275, a protective sheet 240, and a pen 280 that dispenses a disappearing ink while writing. (Additional detail is also shown of the pixel electrodes 260 that are arranged in an array to provide image updates. The pixel electrodes 260 are controlled by thin-film transistors 250 that are coupled to the display driver.) Because the pen 280 includes an inductive coil, the motion of the pen interacts with the electromagnetic fields produced by the digitizing layer 275, allowing the digitizing layer to determine a position in the X-Y plane defined by the digitizing layer 275. The digitizing layer 275 is typically coupled to memory so that the movement of the pen 280 can be recorded in an electronic file, whereby the electronic file may be printed, converted into a .pdf document, e-mailed, etc. Furthermore, the electronic file may be the basis for a global update to the image, e.g., via the display driver; after some amount of writing has been completed. As shown in FIG. 2, the image on the display surface has been updated to reflect the position of the pen 280.

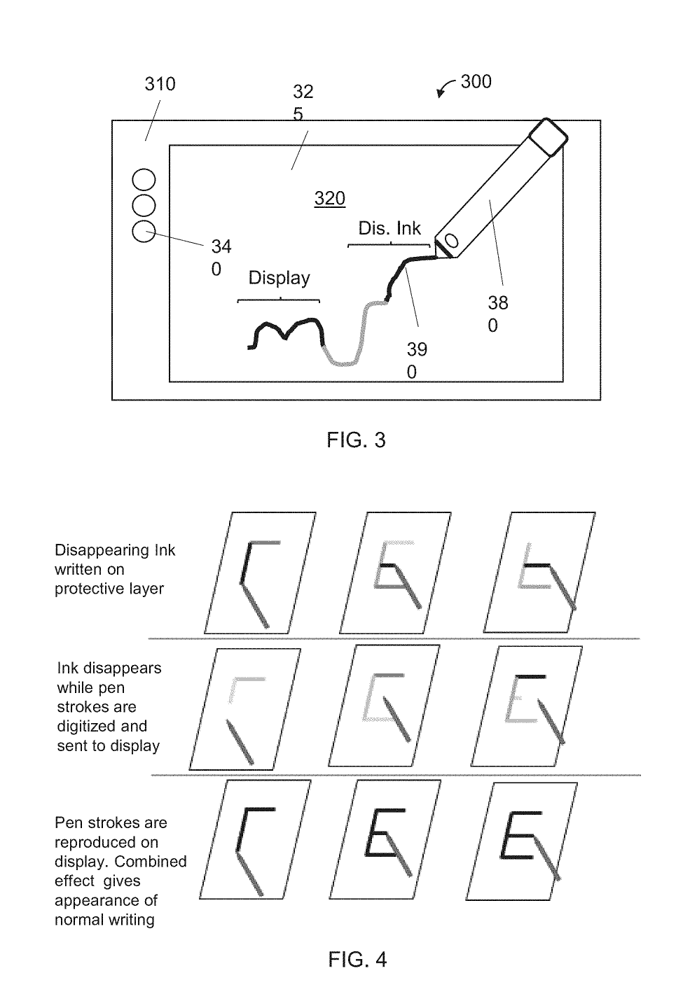

A writeable system 300 of the invention is shown in FIG. 3. The writeable system 300 includes an electrophoretic display 320 that is covered by a protective sheet 325, and a pen 380 that includes a source of disappearing ink and is configured to interact with the digitizing layer. As shown in FIG. 3, the writeable system 300 resembles a conventional electronic writeable tablet, including a housing 310 and interfacial controls 340 which can be real or virtual. That is, the interfacial controls 340 can be separate buttons, dials, etc., or the interfacial controls 340 can be generated by the operating software and displayed/interfaced through the display.

In most embodiments the protective sheet 325 is chemically-resistant, anti-glare, anti-scratch, and has the correct surface energy level to allow the disappearing ink to wet the surface for a good writing experience. The protective sheet 325 can be made from specialty materials or from typical protective sheet materials, such as glass, with a suitable coating to make the protective sheet materials chemically-resistant, anti-glare, and anti-scratch. For example, the protective sheet 325 can be high-impact, anti-scratch glass, such as GORILLA® glass (Corning Incorporated, Corning, N.Y.). In other embodiments, the protective sheet 325 is polyethylene terephthalate (PET), polycarbonate (PC), polymethyl methacrylate (PMMA), polyethylene naphthalate (PEN) or cyclic olefin polymer (COP). Any of the protective sheet 325 materials can include a surface coating layer with oxide, fluorine, silicone material or functional acrylic groups to adjust the hardness, chemical resistance and surface energy.

As a user writes with the pen 380 on the writeable medium 320, the disappearing ink 390 from the tip of the pen 380 will provide the look and feel of regular writing. At the same time that the pen 380 is laying down disappearing ink 390, the digitizing layer is recording the position of the pen 380. As the disappearing ink fades, the writing will be supplanted with an electrophoretic image of the same pen stroke. Thus, the writing is displayed and captured electronically just like “normal” writing. Of course, because the disappearing ink will disappear across the entire display surface in a short amount of time, it is very straightforward to refresh the writing surface. A user would merely touch the appropriate button and the electrophoretic display 320 will revert to white. The previously-written ink would not be visible because it has already disappeared.

FIG. 4 shows a step-by-step illustration of how the text is updated. The top row of FIG. 4 shows how the various pen strokes of the letter “E” are written with the pen, which lays down a short-lived ink. As shown in the middle row of FIG. 4, the ink disappears at the same time that the pen strokes are digitized and reproduced on the display. Because the display is updated on the order of 100-200 ms, or quicker, the overall effect is one of simply writing, as shown in the bottom row of FIG. 4. Additional corrections, such as smoothing and text correction, may also be performed on the recorded positions of the pen prior to be displayed as the corresponding pen stroke.

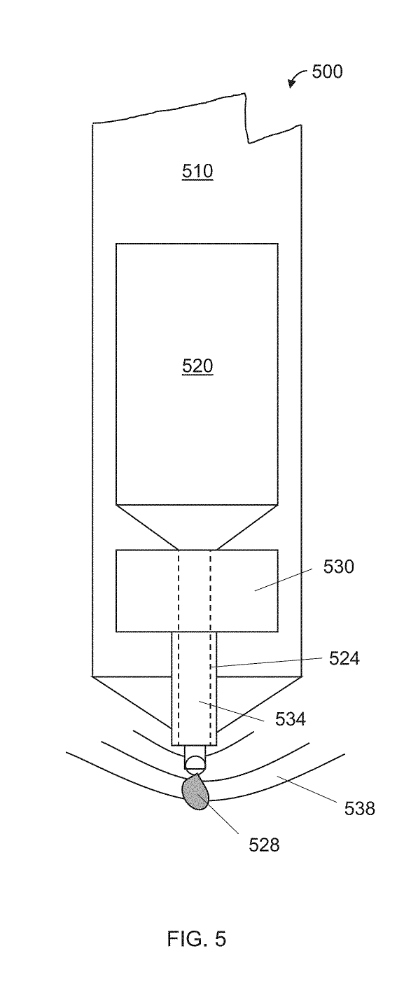

An exemplary pen design that provides a source of disappearing ink as well as a mechanism for tracking the motion of the pen is shown in FIG. 5. FIG. 5 shows a cut-away of the writing end of a disappearing ink-dispensing and electromagnetic induction (EMR) capable pen 500. The pen comprises a body 510 which is held by the user and which houses the electrical components needed for functionality. A reservoir 520 holds the disappearing ink. The reservoir 520 may have a lid or some other mechanism to allow the reservoir 520 to be refilled. Alternatively, the reservoir 520 can take the form of a cartridge that is replaced once the disappearing ink runs low. The reservoir is coupled to a stylus 534 that runs through a sheath 524, and extends to the tip, where the disappearing ink 528 is dispensed. As shown in FIG. 5, the stylus includes a roller ball to improve the writing experience, however the other embodiments such as felt tips are also suitable. Within the sheath 534 is an inductive coil that is coupled to electronics 530 that allow the electromagnetic flux created during motion of the pen to be tracked and broadcast back 538 to the digitizing layer.

Several formulations of disappearing ink are suitable for use with the invention. For example, a dilute basic solution of thymolphthalein indicator (5′,5″-diisopropyl-2′,2″-dimethylphenolphthalein, C₂₈H₃₀O₄) can be prepared by mixing 1 part of thymolphthalein indicator solution (Sigma-Aldrich, Milwaukee, Wis.) with 10 parts of ethyl alcohol and then diluting the thymolphthalein/alcohol mixture an additional ten-fold with water. The resulting dilute solution has a pH of between 8 and 12, i.e., around 10. When the dilute solution is exposed to air, the carbon dioxide in the air rapidly neutralizes the basic solution, turning the solution colorless. Thus, the mixture works as a disappearing ink. The lifetime of the ink can be adjust somewhat by altering the pH of the initial solution. Additionally, the rheology of the disappearing ink can be altered by adding surfactants and/or thickening agents. Alternative embodiments may use other basic formulations that change appearance after exposure to air. For example, phenolphthalein indicator (3,3-Bis(4-hydroxyphenyl)-1(3H)-isobenzofuranone; C₂₀H₁₄O₄; Sigma-Aldrich) can be used in the same formulation, above, to create a red disappearing ink. Because of the optical properties of phenolphthalein, the solution pH will have to be adjusted to between pH 8 and pH 10, e.g., around pH 9.

Because the disappearing ink is primarily a weak base, the electrophoretic display includes a protective sheet that protects the electrophoretic medium and electrodes. Typically, the protective sheet creates a vapor barrier so that the ink cannot interact with the electrical components. Additionally, the protective sheet must not react with the weak base nor interfere with the readability of the display. Thus, durable plastic materials such as high density polyethylene (HDPE) and polyvinyl chloride (PVC) can be used for the protective sheet. Other durable transparent materials may also be used. In some embodiments, the protective sheet will be textured so that the pen has the feel of natural writing or so that the ink coats in a uniform fashion.

In some embodiments, it will be helpful to include an absorbent wipe for clearing the used ink from the surface of the electrophoretic display. Alternatively, the writing system may include an applicator having a mild acid solution to assure that the basic solution is completely neutralized and all residue is removed from the protective sheet. For example, the mild acid solution can be a dilute solution of acetic acid (i.e., dilute vinegar). In some embodiments, the pen may include an eraser with a small amount of acid solution.

Accordingly, the system allows for a fast optical response to pen writing but also records the writing so that it can be stored electronically and shared. For example, in some embodiments, the display controller will detect when the pen breaks contact with the display and refresh the screen.

### Definitions

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” or “gray scale” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and mufti-stable displays.

From the foregoing, it will be seen that the present invention can provide a writeable electro-optic display medium and a light-emitting pen for causing a nearly instantaneous update of a display controlled by light-sensitive pixel electrodes. It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A writeable system comprising:
an electrophoretic display including:
a light-transmissive front electrode,
a protective sheet covering the light-transmissive front electrode,
an array of pixel electrodes,
an electrophoretic medium, sandwiched between the light-transmissive front electrode and the array of pixel electrodes, the electrophoretic medium comprising charged particles that move in the presence of an electric field, and
a digitizing layer configured to locate a touch on the electrophoretic display; and
a pen including a source of disappearing ink, the pen being configured to write on the protective sheet with the disappearing ink while interacting with the digitizing layer.

2. The writeable system of claim 1, wherein the digitizer locates the position of the pen with electromagnetic sensing.

3. The writeable system of claim 1, wherein the digitizer locates the position of the pen with capacitive sensing.

4. The writeable system of claim 1, further comprising a power source and a display driver operatively coupled to the array of pixel electrodes.

5. The writeable system of claim 4, further comprising memory operatively coupled to the digitizing layer and the display driver, and configured to receive position information from the digitizing layer and then send the position information to the display driver.

6. The writeable system of claim 4, wherein the power source is operatively coupled to the digitizing layer.

7. The writeable system of claim 1, wherein the disappearing ink comprises thymolphthalein or phenolphthalein.

8. The writeable system of claim 7, wherein the disappearing ink has a pH between 8 and 12 while stored in the source.

9. The writeable system of claim 1, further comprising an eraser having an applicator and an acidic cleaning agent.

10. The writeable system of claim 9, wherein the acidic cleaning agent comprises acetic acid.

11. The writeable system of claim 1, wherein the protective sheet is textured to improve the writing performance of the pen.

12. The writeable system of claim 1, wherein the protective sheet comprises high density polyethylene (HDPE) or polyvinylchloride (PVC).

13. The writeable system of claim 12, wherein the protective sheet is textured to improve the writing performance of the pen.

14. The writeable system of claim 1, wherein the protective sheet comprises micro-etched glass.

15. The writeable system of claim 14, wherein the protective sheet is textured to improve the writing performance of the pen.

16. A pen for writing on an electrophoretic display, comprising a source of disappearing ink and an inductive coil coupled to circuitry.

17. The pen of claim 16, wherein the disappearing ink comprises thymolphthalein phenolphthalein.

18. The pen of claim 16, wherein the disappearing ink has a pH between 8 and 12 while stored in the source.

19. The pen of claim 16, further comprising a power source.
